(19) United States
(12) Patent Application Publication
(10) Pub. No.: US 2003/0141392 A1
(43) Pub. Date: Jul. 31, 2003

(54) Electrospray emitter

(76) Inventors: Steffan Nilsson, Uppsala (SE); Magnus Wetterhall, Uppsala (SE); Jonas Berquist, Uppsala (SE)

Correspondence Address: YOUNG & THOMPSON, 745 SOUTH 23RD STREET 2ND FLOOR, ARLINGTON, VA, 22202

(21) Appl. No.: 10/297,718

(22) PCT Filed: Jun. 8, 2001
(86) PCT No.: PCT/SE01/01303

(30) Foreign Application Priority Data
Jun. 8, 2000 (GB) 0002146.9
Nov. 17, 2000 (SE) 004233.3

(51) Int. Cl. B05B 5/00

(52) U.S. Cl. 239/690

(57) ABSTRACT

The invention relates to an electrospray emitter (1′; 1″; 1′″), comprising an essentially tubular member (2; 5; 7) having an inlet end and an outlet end. There is provided a spray aperture (4) in the outlet end, having an inner diameter suitable for the generation of electrospray usable in mass spectrometry. At least a surface portion of the emitter comprises a conductive polymer composition that is stable in conditions prevailing during electrospray.

The present invention relates to mass spectrometry (MS) in general, and in particular to novel electrospray ionization (ESI) emitters for the production of electrosprays and/or nanosprays for MS.

### BACKGROUND OF THE INVENTION

Metallized (e.g. gold-coated) fused silica capillaries have been used extensively for sheathless ESI emitters in mass spectrometry. However, this style of emitter has been plagued by the instability of the metal coating. Thus the coating must be re-applied after a short time (2-8 hours) or the capillary is simply disposed.

At a conference Analysdagarna, Uppsala, 1999, there was published a paper “Designs of highly durable Sheathless Emitters for Electrospray Ionisation-Mass Spectrometry” by Stefan Nilsson, David R. Barnidge, Ulrike Selditz, Karin E. Markides, Hakan Rapp and Klas Hjort.

In this paper there was presented two new approaches to make large numbers of on-column emitters with very stable coatings. The first approach, referred to as the “fairy dust” technique, is simply the application of 2 μm gold particles on shaped, pulled or blunt column tips by the use of polyimide or epoxy glue. The particles can be applied after modification of the capillaries, such as packing or wall coating. The approach has proved to supply emitters capable of giving a stable spray for more than 2000 hours. “Fairy dust” emitters could easily be fabricated in any lab without the need of expensive instrumentation or prerequisite skills.

The second approach includes evaporative coating of chromium-gold on shaped capillaries. However, no extra polyimide was removed, hence excellent physical stability was conserved throughout the capillary. In fact, only the shaped portion of the capillary (0.5-1 mm) has the polyimide removed. Metals are then deposited on both the glass surface and the polyimide. The most important step in applying any metal to a glass surface in an evaporation process is to first have the surface free from particles and water. This requires cleaning in H₂O₂/NH₃ and heating of the tips (>200° C.) in vacuum prior to chromium deposition. Since gold adheres to a glass surface more strongly when an underlay of chromium is applied, vapour deposition of chromium is done first. Deposition of gold is started immediately afterward to prevent applying the gold onto oxidised chromium. Capillaries coated using the aforementioned criteria have resulted in ESI emitters that have a metal coating stable for 100 hours and excellent resistance to breaking and discharges.

Gold-coated capillaries are ideally suited for high efficient separations since the separation is performed from the column inlet all the way to the electrospray.

The fairy dust technique facilitates the fabrication of “Plug-and-Play” μLC-MS columns where no couplings are necessary. Thereby, several things are achieved:

1) No dead volumes—lowest possible band broadening.

2) Separation all the way to the emitter

3) Sheathless electrospray—Enhanced sensitivity

4) Easy setup, never worry about leaks or loss of spray

However, while the above described techniques have many advantages, they still suffer from certain drawbacks.

The fairy dust coated glass capillary uses gold particles with a diameter of the order of 2 μm. This puts a lower limit to the practical size of the diameter of the spray aperture. Also the fairy dust coated glass capillary is comparably expensive since the gold dust used is expensive.

For the variant with metal coating on glass, it may happen that the metal is “flaked-off” during operation already after 2-8 hours, although it may be operable as long as 100 hours when conditions are favourable. If the tip is exposed to electrical discharges, which can easily happen during operation, it may also happen that the metal coating is lost. Such flaking will render the tip unusable, and it has to be replaced with a new one.

Also, the process of making the metal-coated emitters is fairly complex and rather expensive.

Other commercially available nano-spray-tips made of coated glass, usually have a closed tip as delivered, and must be opened by breaking the tip to produce the spray aperture. This means that it is virtually impossible to control the diameter of the aperture. If the opening is too large or too small, it may also happen that the entire capillary with the sample in it must be discarded.

It is also known to coat a glass capillary with an epoxy resin containing silver, in order to make a conductive surface suitable for establishing a point of electrical contact. However, the durability of such a device is far from sufficient, since the silver will oxidize rapidly in the very severe electrochemical conditions prevailing in an electrospray.

In another variant of a sheathless electrospray ionization emitter, referred to as the “liquid junction”, the electrospray potential is applied onto the sprayed solution before it reaches the spray aperture. This is most commonly accomplished by a stainless steel coupling, provided between the inlet capillary and the spray needle, and functioning to distribute the electrospray potential and current. It can also be implemented as a thin layer of gold or another metal. The electrochemical stress on the conducting part of the emitter in a liquid junction is the same as for the “pure” sheathless approach. Thus, the durability of those emitters will still be an issue to consider, especially for those with thin films of metal. Also the liquid junction is known to increase the noise and the alignment of the two capillaries within the liquid junction is sometimes difficult to achieve. Furthermore, when capillary electrophoresis is performed the electrophoretic separation can not be maintained all the way through the spray needle.

In U.S. Pat. No. 6,015,509 (Angelopoulos et al) there is disclosed a composition containing a polymer and conductive filler and use thereof, useful as corrosion protecting layers for metal substrates, for electrostatic discharge protection, electromagnetic interference shielding, and as adhesives for interconnect technology as alternatives to solder interconnections. In addition, films of polyanilines are useful as corrosion protecting layers with or without the conductive metal particles.

In a conference abstract entitled “Polyaniline: A New Coating for Nanospray Emitters for Improved Durability” by Thomas P. White et al there is disclosed polyaniline (PANI) coated nanospray emitters. They were prepared with two different forms of PANI, a water-soluble form and a xylene-soluble form. The two different types of emitters were tested and compared in regards to emitter performance and stability. In both cases, PANI films were cast onto uncoated borosilicate glass emitters purchased from New Objective.

### SUMMARY OF THE INVENTION

Thus, there is still room for improvement in the art of electrospray emitters, and the invention provides such an improvement, by the electrospray emitter defined in claim 1.

Thereby at least a surface portion of the emitter, near the spray aperture, comprises a conductive polymer composition, said conductive polymer being stable in conditions prevailing during electrospray. In an embodiment, the emitter is made of a polymer, e.g. polypropylene that has been made conductive by the addition of appropriate amounts a suitable conductive additive. The composition must be electrochemically inert in the conditions prevailing during electrospray. In particular the conductive polymer and/or polymer with additive should not degrade at an electric field of 1-10 MV/m. It should also not degrade when exposed to current densities of, up to 1 mA/mm², at the interface between emitter and liquid. The conductive polymer used should also be resistant to the solvents used for electrospray, e.g. organic solvent and/or water, and furthermore it should be resistant to oxidation/reduction of water on its surface. Mechanical robustness is also desirable.

A suitable and preferred additive is graphite.

In a first embodiment the entire emitter is made of this material, e.g. polypropylene/graphite mixture. This renders the emitter very inexpensive to manufacture, and it also is extremely stable over a long time. This emitter can be used as a polymeric nanospray emitter (we therefor call it the Polymeric Nanospray Emitter as a working name), although it can be used for ordinary electrospray as well, all depending on the diameter of the outlet end and the flow rate in the spray.

By making the emitter entirely of a polymer material, it becomes mechanically stable, it does not break easily or at all, and can thus be handled in a much more convenient manner. It may thus be used as a sampling device for drawing samples directly from tissue, without risk of it breaking. The emitter is extremely resistant to discharges and the tip can easily be restored by cutting it with a scalpel. This can be performed without losing the sample in the emitter. Furthermore the emitter can be packed with a chromatographic media in order to perform online separation, purification or other modifications of the analytes before MS analysis.

The nature of the emitter also allows integration into a microseparation device, a microchip structure etc., made of silica or polymer or other suitable material, in order to provide the possibility to have an electrospray formed directly from the device.

It is also possible to integrate a conductive filler such as graphite in the surface of the polymer only. In a second embodiment the polypropylene/graphite is applied as a coating on the emitter exterior. The emitter can thereby be made of e.g. fused silica. By coating the glass capillary, it becomes less brittle (these emitters are referred to as “Black Jack” emitters as a working name).

If it for some reason is desired to use a glass capillary, instead of a polymer capillary, an advantage of the invention is that the capillary can be coated while a sample is present in the capillary or on a packed or inner-surface coated capillary, since the polymer coating can be done extremely rapidly. There will be virtually no heat dissipation in the sample from the polymer melt that could affect the sample, the packing material or the coating.

In still another embodiment a mixture of polyimide/graphite is applied as a coating on the emitter exterior. This emitter needs to be cured in an oven before use (these emitters are referred to as “Black Dust” emitters as a working name).

In still another embodiment the emitter is made of metal, preferably steel, coated with the polymer. An advantage with a metal capillary is that it is rigid and can thus be used as a sampling device by insertion into the tissue of interest, without the risk of breaking, which would easily happen with a glass capillary as such. By coating the metal also the tendency of metal to absorb species from the sample is avoided, and the risk of metal contamination of the sample is eliminated.

Generally the polypropylene is much more inert than both glass and metal, which is an advantage in itself.

Other suitable polymers are exemplified by compositions containing a polymeric matrix and a conductive filler component. The conductive filler component comprises conductive particles, such as graphite, and can also comprise a polymer selected from the group consisting of substituted and unsubstituted polyparaphenylenevinylenes, substituted and unsubstituted polythiophenes, substituted and unsubstituted polyazines, substituted and unsubstituted polyparaphenylenes, substituted and unsubstituted polyfuranes, substituted and unsubstituted polypyrroles, substituted and unsubstituted polyselenophene, substituted and unsubstituted poly-p-phenylene sulfides and substituted and unsubstituted polyacetylenes, and mixtures thereof and copolymers thereof.

In still another embodiment the emitter is made of a hollow member, the bulk of which comprises silica, glass, quartz, polymer, metal or another supportive material, and the described conductive coating is applied to the interior of any of this hollow member. The electrospray ionization potential/current is applied to this interior coating, thus rendering the hollow member usable as an electrospray emitter.

### BRIEF DESCRIPTION OF THE DRAWINGS

FIG. 1a shows an emitter made entirely of polypropylene/graphite according to the invention during operation;

FIG. 1b shows an electrospray generated with the emitter of FIG. 1a;

FIG. 2a shows an emitter made of a polymer coated glass capillary according to the invention during operation;

FIG. 2b shows an electrospray generated with the emitter of FIG. 2a;

FIG. 3 shows a polymer coated metal emitter according to the invention;

FIG. 4 is an MS recording of a separation of three peptides using a prior art emitter of the “fairy dust” type;

FIG. 5 is a CE-MS recording of a separation of nine peptides using a prior art emitter comprising a chromium-gold coated capillary tube;

FIG. 6 is an MS graph recorded using an emitter according to a first embodiment of the invention;

FIG. 7 is an ion profile (intensity vs. time) using an emitter according to a first embodiment of the invention;

FIG. 8 is an MS graph recorded using an emitter according to a second embodiment of the invention; and

FIG. 9 is an ion profile (intensity vs. time) using an emitter according to a second embodiment of the invention.

### DETAILED DESCRIPTION OF PREFERRED EMBODIMENTS OF THE INVENTION

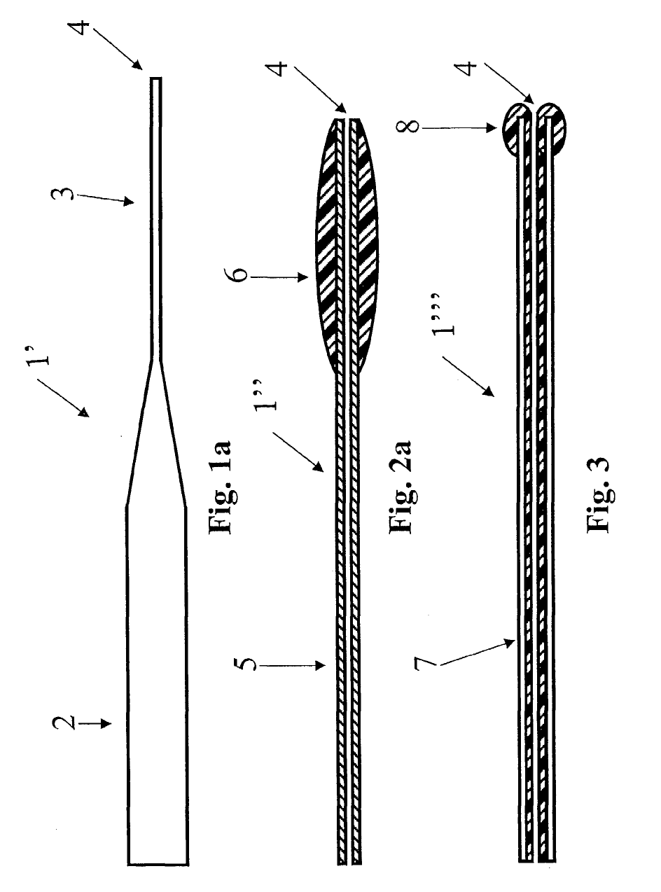

In FIG. 1a there is shown a first embodiment of an electrospray emitter 1 according to the present invention.

It comprises an essentially tubular body 2 made of polypropylene with graphite added to render it conductive. Thereby it will become black, and thus completely opaque. It has a proximal end and a distal end. The outlet end is drawn to form a capillary 3, having a distal spray aperture 4, the inner diameter of which at the very distal end is <50 μm. Preferably it is <20 μm, and for certain applications it is desirable that it is <5 μm. Methods for pulling e.g. polymer materials are known to the man skilled in the art, and do not form part of the invention per se.

As an example, the pulling of the capillary can be simply done by heating the material with an air gun and pulling the material until it takes on the desired shape and dimensions.

FIG. 1b shows an electrospray generated in an MS set-up, using the emitter according to the embodiment shown in FIG. 1a. As is evident from FIG. 1b, the electrospray is excellent, which is confirmed by the results presented in the following examples.

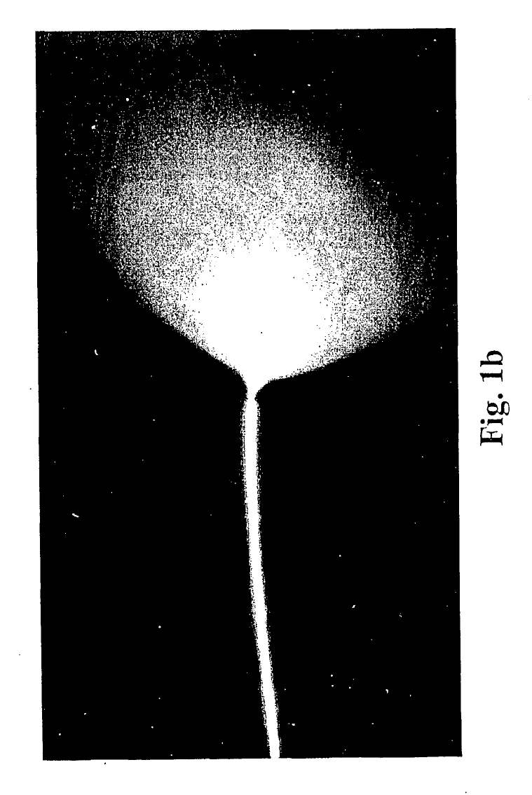

In FIG. 2a a second embodiment of an emitter 1″ according to the invention is shown in a schematic cross section. Dimensions are not to scale for clarity.

It comprises an essentially tubular body of a material e.g. glass or polymer material, that has been shaped to form a capillary part 5. The entire emitter can be coated with conductive polymer, e.g. polypropylene/graphite (PP/G), but it is also conceivable to just coat the distal capillary portion of the emitter. In the embodiment of FIG. 2a only the region near the spray aperture 4 is coated. In this way the contents of the body of the emitter can be visibly controlled if the body is made of transparent material, e.g. glass or pure polypropylene. Thus, the emitter is coated 6 with PP/G by applying the polymer on the surface. In the simplest approach to coating, the polymer (PP/G) is simply melted, and the melt is applied onto the surface by brushing or alternatively by dipping into the melt. This procedure is suitable for automation. Other possible methods of coating are by vapor deposition techniques, vapor phase polymerization directly onto the substrate surface etc.

In order to make better electrical contact it may be desirable to have that part of the emitter having a larger diameter coated, which than would prevent easy inspection of the contents of the emitter, since this part will become opaque (black). Therefore, it is contemplated within the inventive concept to take measures so as to leave a narrow region of the emitter, extending in the longitudinal direction, uncoated. This creates a narrow window making visual inspection of the contents of the emitter during operation.

This window can suitably be accomplished by masking off the surface while melting the polymer onto the surface.

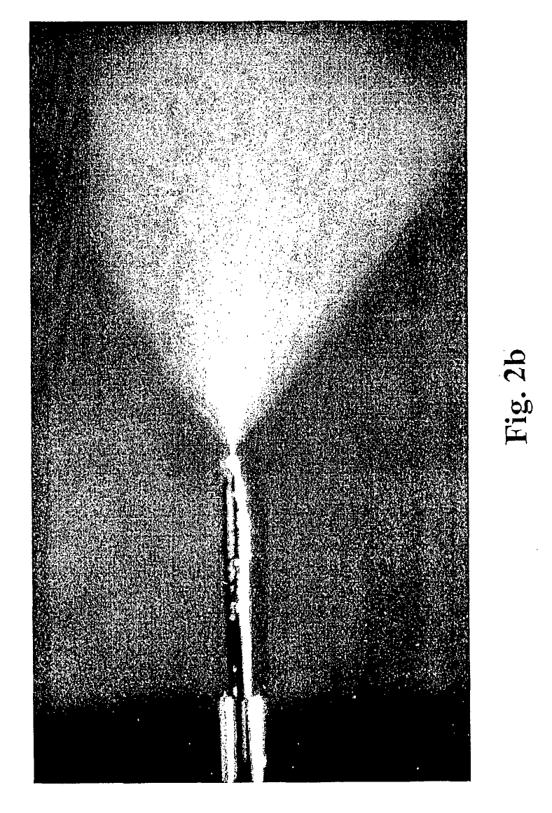

In FIG. 3 a further embodiment of an emitter 1′″ according to the invention is shown. It comprises a metal capillary 7, the inner side of which is coated with a polymer 8 having electrical conductivity, and preferably also at least a portion of the outer surface is coated.

It is also conceivable to produce the emitter by extrusion of different materials, e.g. pure polypropylene (transparent) and polypropylene with graphite (black) through an extrusion die such that windows will be formed directly during extrusion.

In still another embodiment of the invention, the emitter is made of a polymer, e.g. polypropylene that has been made conductive by the addition of appropriate amounts a suitable conductive additive. The composition must be electrochemically inert in the conditions prevailing during electrospray. In particular the conductive polymer and/or polymer with additive should not degrade at an electric field of 1-10 MV/m. It should also not degrade when exposed to current densities of, up to 1 mA/mm², at the interface between emitter and liquid. The conductive polymer used should also be resistant to the solvents used for electrospray, e.g. alcohol and/or water, and furthermore it should be resistant to oxidation/reduction of water on its surface. Mechanical robustness is also desirable.

In a still further aspect of the invention, the polymeric nanospray emitters as disclosed above, can be packed with an adsorption media. The purpose is to enable selective pre-concentration and solid phase extraction or on-line enzymatic cleavage, or separation within the emitter itself, prior to elution and nanospray analysis. Thereby, it will be possible to provide a single self-contained preparation and analysis unit, that significantly would facilitate many types of preparative analyses, that until now may have required complex apparatus, and operation in several steps, with accompanying risks of error in the handling and loss of the analytes.

Suitable media for the purpose of this aspect of the invention are known from the art of chromatography, and include SPE media, affinity media, enzymatically coated media, HPLC packing material etc.

These media are easily packed into the tip by applying a small volume (typically a few μl) of a slurry of the media in question in a suitable liquid. Because of the narrow and restricted end of the tip the media particles will not come through and will therefore be easily packed by addition of repeated volumes of buffer or organic solvents. In this way a column with an adsorptive bead can be made, and once this has been done, the column can be conditioned, sample added, the column rinsed, and finally the analytes can be eluted directly into the ESI, or alternatively, directly separated on the column itself. The tip can then be reused as an ordinary column.

The packed nanospray emitters facilitate on-line pre-concentration and purification in the emitter prior to elution and MS analysis.

This is a great benefit of the present invention, since selective on-line pre-concentration will speed up the analysis and minimize loss of analytes prior to analysis.

The invention will now be further illustrated by way of the following non-limiting examples.

### EXAMPLE 1

### Comparative, “Fairy Dust”

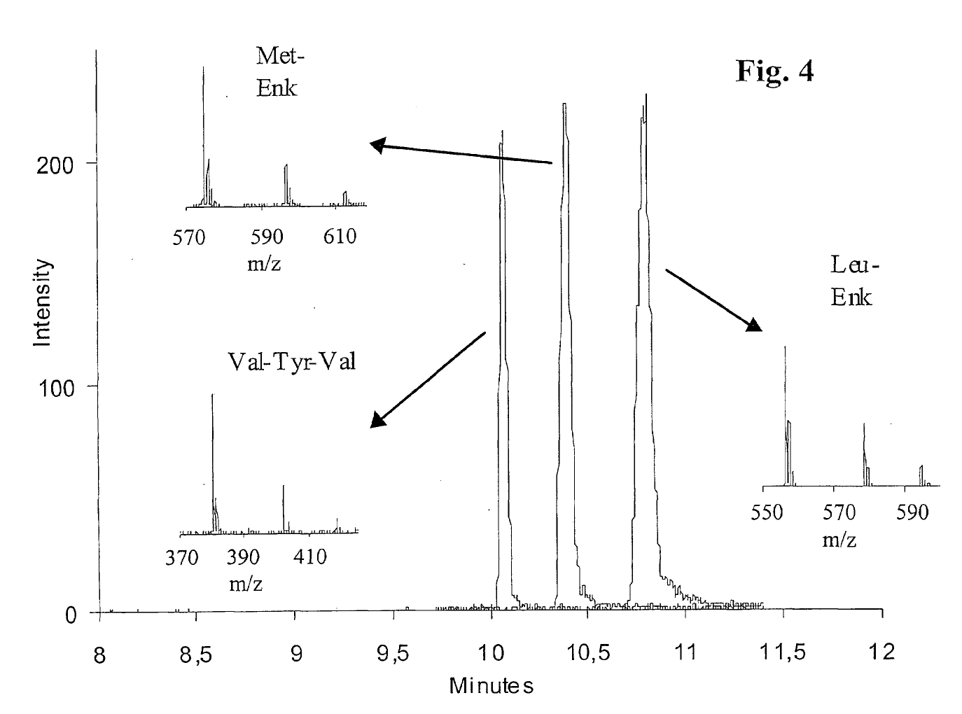

In FIG. 4 there is shown a separation of three peptides, at a concentration of 0.25 μg/mL, using a 22 cm long 150 μm i.d. capillary packed with 3 μm ODS particles retained by a glassfiber frit in the pulled fairy dust coated on-column emitter. Even when using the width at 10% of the maximum height, outstanding plate numbers (N_{0.1 h}/m) were obtained: 2,177,550 for Val-Tyr-Val (RSD: 22.4%), 824,520 for Met-Enk (RSD: 9.6%) and 497,645 plates/meter for Leu-Enk(RSD: 5.1%)

### EXAMPLE 2

### Comparative, Metal Coated Capillary)

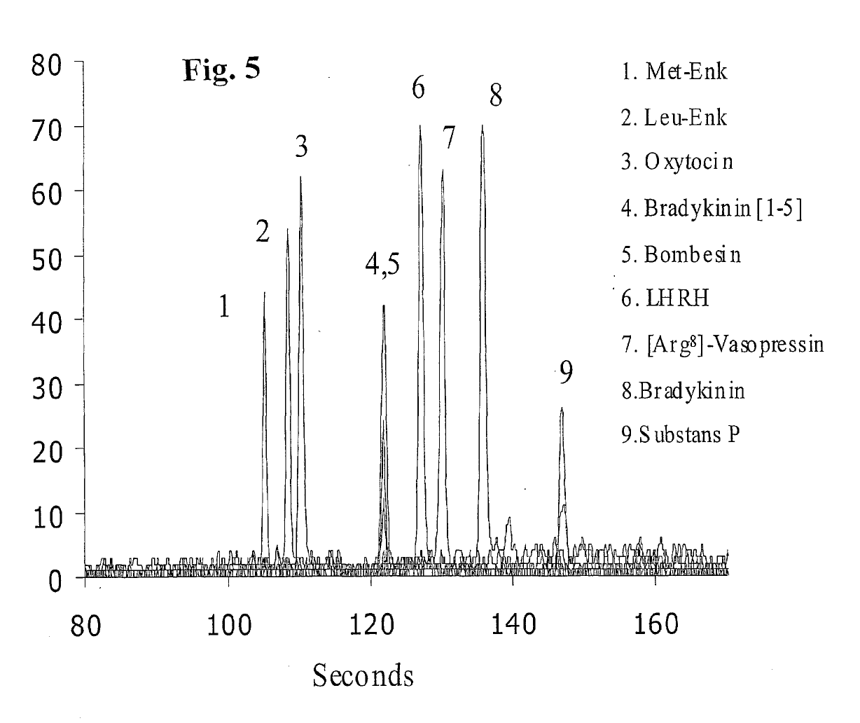

In FIG. 5 there is shown a reconstructed ion electropherogram for a CE/ESI-MS separation of nine neuropeptides, using a 25 μm×50 cm APS coated CE column with the chromium-gold coated emitter. A total of 700 fg of each peptide was hydrodynamically injected onto the column. The separating voltage was set at 600 V/cm.

All but two peptides are resolved in less than three minutes.

### EXAMPLE 3

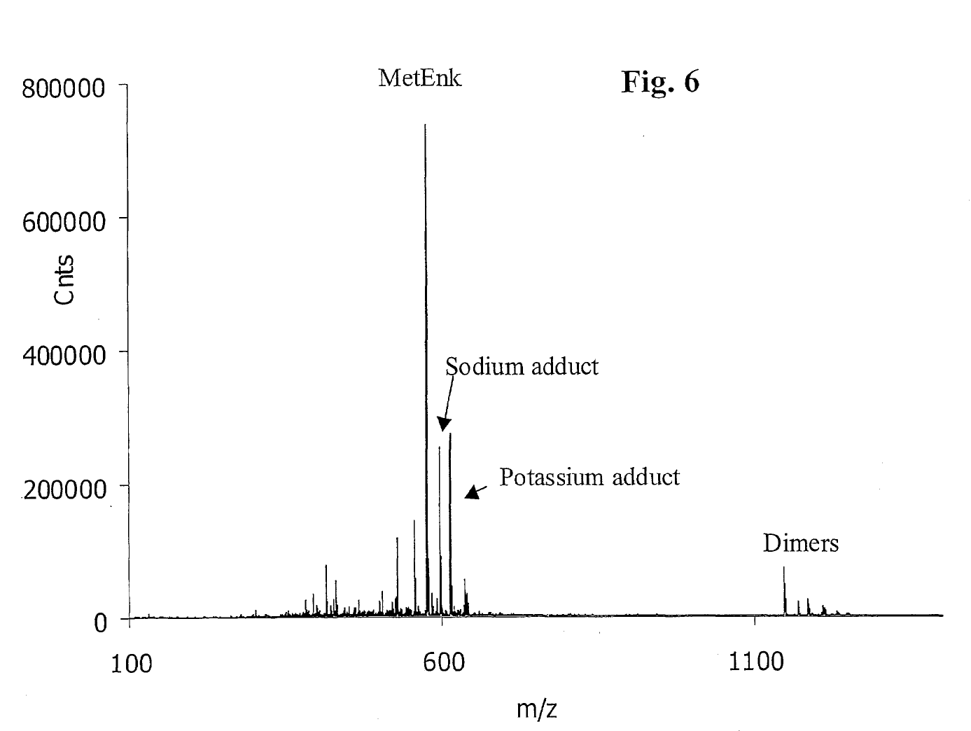

In FIG. 6 there is shown mass spectrometry data collected from a solution of 3 mg/ml of methionine enkephalin (a neuropeptide) dissolved in water:acetonitrile:acetic acid in volumetric proportions 50:50:1. The electrospray generating the ions was obtained from an electrospray emitter containing the sample and held at a high potential. The emitter was made by drawing a conductive polypropylene pipette tip to a capillary. The electrical resistance over the drawn pipette tip was 40 kOhm/cm. The flow necessary for spray formation was generated by the spray itself, i.e. no supporting driving force, such as applied pressure, was needed.

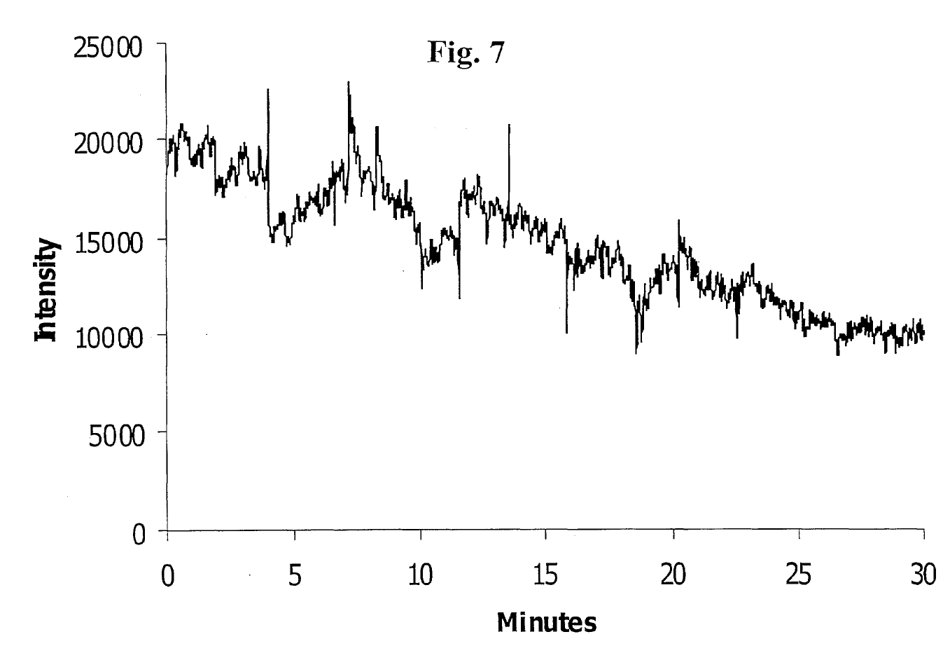

FIG. 7 illustrates selected ion profile (intensity of m/z 574 as a function of time) of methionine enkephaline sprayed at a concentration of 3 mg/mL. The flow is estimated to be below 100 nL/min. The profile shows a relatively stable signal considering that no support, such as pressure applied to the emitter, assists in the spray generation.

### EXAMPLE 5

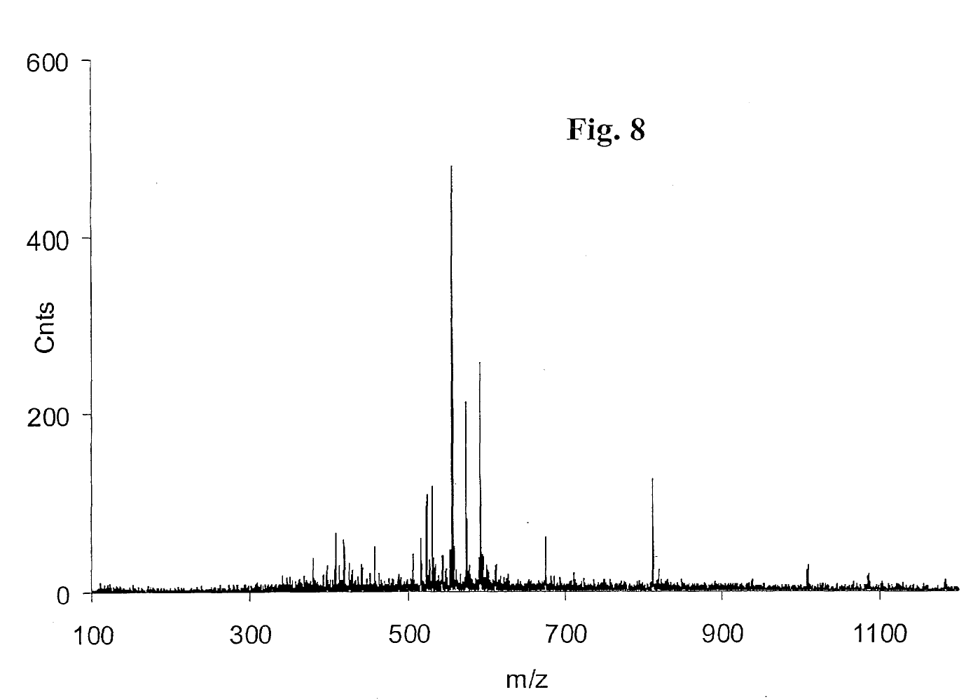

FIG. 8 shows a mass spectrum of the 9 peptide standard, (Sigma P-2693), all being common neuropeptides. The standard was dissolved in water: acetonitrile:acetic acid in volumetric proportions 50:50:1 (conc: 2 μg/mL of each peptide) collected during 320 milliseconds of the 30 minutes run. The spectra represent a few femtomole of each peptide. As is clear from this graph, there is practically no interference from the material of the emitter, and the S/N ratio is excellent.

The electrospray was generated with a tapered fused silica capillary (25 μm i.d×360 μm o.d, length: 30 cm). The external surface of the emitter end of the capillary was coated with a layer of conductive polypropylene polypropylene and graphite; “Black Jack”). The outer coating was made by melting a graphite containing polypropylene, and pulling the tapered fused silica capillary through the melt of polypropylene.

The sample was continuously infused through the capillary at a flow rate of 400 nL/min, using a syringe pump. An electrospray potential of 3 kV was applied on the emitter end, thus providing a stable sheathless electrospray ionization (ESI). No nebulizer gas or sheath liquid was applied. The necessary electric contact between the sample liquid and the high potential was obtained through the conductive polypropylene coating.

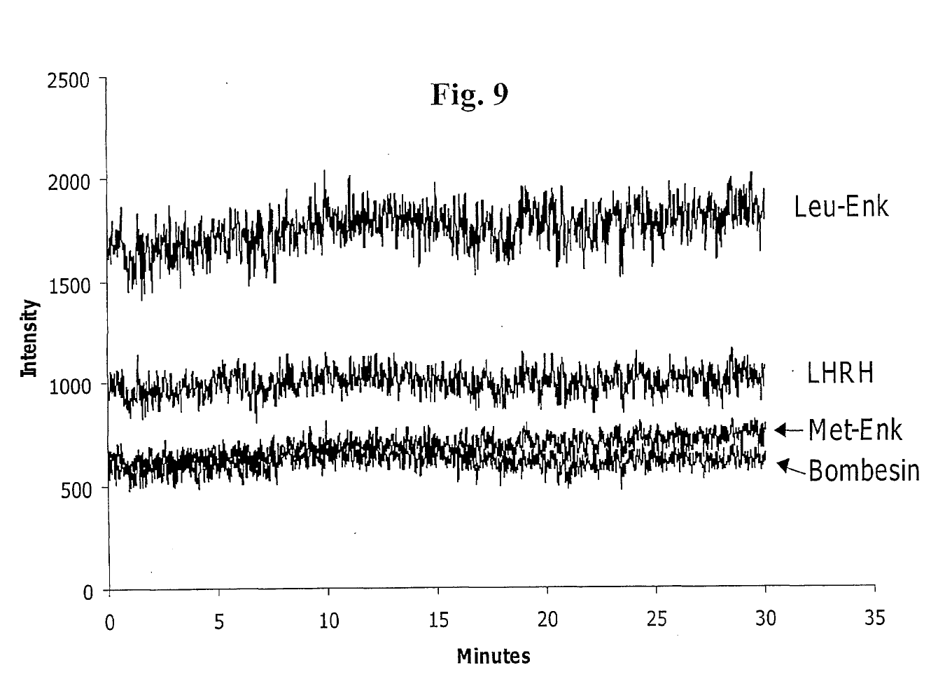

FIG. 9 shows selected ion profiles (intensity of m/z as a function of time) of Leucine-Enkephalin (LeuEnk), Luteinizing Hormone Releasing Hormone (LHRH), Methionine Enkephalin (MetEnk) and Bombesin (four of the 9 peptides in the standard) sprayed at a concentration of 2 mg/mL of each. The sample was continuously infused during 30 minutes at a flow rate of 400 nL/min and a ESI potential of 3 kV. The profile shows very stable signals of the four analytes during the whole run.

### EXAMPLE 6

A fused silica capillary (25 μm i.d×360 μm o.d, length: 30 cm) was mechanically tapered. Polyimide resin and graphite was applied onto the tapered end. The polyimide was polymerized in an oven. In a first experiment the polyimide was first applied and then dusted with graphite. In a second experiment a mixture of polyimide and graphite was applied to the capillary (this approach has been given the working name “Black Dust”). In both cases the tip was made conductive, and using the same set-up as in Example 1, an excellent and stable electrospray was generated for both variants.

The concentration of graphite in the polymer matrix, e.g polypropylene or polyimide should be such that a suitable balance between conductivity and viscosity can be achieved. We have empirically shown that a suitable concentration of graphite in polyimide could be 10-30% by weight.

1. An electrospray emitter (1′; 1″; 1′″) having a spray aperture (4), wherein at least a surface portion (6; 8) of the emitter comprises a conductive polymer composition, said conductive polymer being stable in conditions prevailing during electrospray.

2. The emitter as claimed in claim 1, said stability being sustained for an extended period of time of not less than 50 hours, preferably not less than 100 hours, most preferably more than 300 hours.

3. The emitter as claimed in claim 1 or 2, wherein the conductive polymer is resistant to oxidation/reduction of water on its surface.

4. The emitter as claimed in claim 1, 2 or 3, wherein the conductive polymer does not degrade at an electric field of 1-10 MV/m.

5. The emitter as claimed in any of claims 1-4, wherein the conductive polymer does not degrade when exposed to current densities of, up to 1 mA/mm², at the interface between emitter and liquid.

6. The emitter as claimed in any of claims 1-5, wherein the conductive polymer is resistant to the solvents used for electrospray, e.g. organic solvent and/or water.

7. The emitter as claimed in any preceding claim, which is mechanically robust.

8. The emitter as claimed in any preceding claim, wherein conductive additives are integrated at least in the surface region of the polymer composition so as to render it conductive.

9. The emitter as claimed in any preceding claim, wherein the emitter is entirely made of a polymeric composition.

10. The emitter as claimed in any preceding claim, wherein the conductive particles are distributed throughout said conductive polymeric composition.

11. The emitter as claimed in any preceding claim, wherein the emitter is made of a transparent polymeric material, and wherein the conductive particles are integrated in the polymer so as to leave at least one transparent window extending from the tip and in the longitudinal direction of the emitter.

12. The emitter as claimed in claim 3, wherein the emitter material is made of glass, and the polymeric composition is applied as a coating on the glass.

13. The emitter as claimed in any of claims 10-12, wherein a region at the spray aperture is coated with said polymeric composition containing conductive particles.

14. The emitter as claimed in any preceding claim, wherein the inner diameter of the spray aperture is less than 50 μm, preferably less than 20 μm, and most preferably less than 5 μm.

15. The emitter as claimed in any preceding claim, wherein said polymer composition is selected from the group consisting of compositions containing a polymeric matrix and a conductive filler.

16. The emitter as claimed in claim 15, wherein the conductive filler component comprises conductive particles and a polymer selected from the group consisting of substituted and unsubstituted polyparaphenylenevinylenes, substituted and unsubstituted polythiophenes, substituted and unsubstituted polyazines, substituted and unsubstituted polyparaphenylenes, substituted and unsubstituted polyfuranes, substituted and unsubstituted polypyrroles, substituted and unsubstituted polyselenophene, substituted and unsubstituted poly-p-phenylene sulfides and substituted and unsubstituted polyacetylenes, and mixtures thereof and copolymers thereof.

17. The emitter as claimed in any preceding claim, wherein the polymeric composition comprises a polymeric matrix of polypropylene and wherein the conductive particles are graphite particles.

18. The emitter as claimed in any of claims 1-16, wherein the polymeric composition comprises a polymeric matrix of polyimide and wherein the conductive particles are graphite particles.

19. The emitter as claimed in claim 17 or 18, wherein the graphite particles are present at a suitable concentration by weight of graphite in the polymer.

20. The emitter as claimed in claim 19, wherein the concentration of graphite is 10-30% by weight.

21. An electrospray emitter (1′; 1″; 1′″), comprising
an essentially hollow member (2; 5; 7) having an inlet end and an outlet end;
an electrical contact, interior or exterior, with the sprayed solution where the necessary potential for electrospray formation can be applied, and where the electrochemical reactions for generation of the electrospray current can occur;
a spray aperture (4) in the outlet end, having an inner diameter suitable for the generation of electrospray usable in mass spectrometry;
characterized in that
at least a portion of the emitter is made of a polymeric composition, wherein at least the surface of said polymeric composition has conductive additives, preferably graphite, integrated in the polymeric matrix.
